(19) United States
(12) Patent Application Publication
(10) Pub. No.: US 2026/0147198 A1
(43) Pub. Date: May 28, 2026

(54) MULTI-PASSAGE CAVITY FOR AN OPTICAL DEVICE FOR MANIPULATING LIGHT RADIATION SPATIALLY

(71) Applicant: CAILabs, Rennes (FR)

(72) Inventors: Bertrand Denolle, Rennes (FR); Gauthier Trunet, Rennes (FR)

(21) Appl. No.: 18/879,173

(22) PCT Filed: May 26, 2023
(86) PCT No.: PCT/EP2023/064254

§ 371 Date: Dec. 26, 2024

(30) Foreign Application Priority Data
Jun. 27, 2022 (FR) 2206382

(51) Int. Cl. G02B 17/00

(52) U.S. Cl. CPC G02B 17/004

(57) ABSTRACT

A multi-passage cavity comprises first and second optical elements respectively having main faces, each bearing a reflective surface, at least one of the reflective surfaces being microstructured. The main faces are positioned facing each other so that the reflective surfaces are arranged according to a defined geometry of the multi-passage cavity. The multi-passage cavity comprises two spacers for assembling the first and second optical elements, the assembly spacers being securely fastened to the main faces of the first and second optical elements to maintain the defined geometry between the two reflective surfaces.

### CROSS-REFERENCE TO RELATED APPLICATIONS

This application is a national phase entry under 35 U.S.C. § 371 of International Patent Application PCT/EP2023/064254, filed May 26, 2023, designating the United States of America and published as International Patent Publication WO 2024/002601 A1 on Jan. 4, 2024, which claims the benefit under Article 8 of the Patent Cooperation Treaty of French Patent Application Serial No. FR2206382, filed Jun. 27, 2022.

### TECHNICAL FIELD

The present disclosure relates to an optical device for manipulating light radiation. More particularly, it relates to an optical device comprising a multi-passage cavity configured to modify the transverse phase profile of light radiation.

### BACKGROUND

Document WO2019129954A1 discloses an optical device, designated by the acronym MPLC (Multi Plane Light Conversion), making it possible to carry out any unitary spatial transformation of light radiation. Such a device was originally proposed in document “Programmable unitary spatial mode manipulation,” Morizur et al., J. Opt. Soc. Am. A/Vol. 27, No. 11/November 2010 and documents U.S. Pat. No. 9,250,454, WO2019129949 and US2017010463 propose further specific embodiments thereof.

In the embodiments proposed by document WO2019129954A1, and with reference to FIGS. 1A and 1B of the present disclosure, the optical device comprises a multi-passage cavity 1, composed of the assembly of a planar support 7 having a receiving surface 7a, an alignment part 4 and two reflective optical elements 3, 3′ placed facing each other. The first optical element 3 has a microstructured main face 3a, facing the interior of the multi-passage cavity 1. This microstructuring is configured to modify the phase of incident light radiation that is reflected a plurality of times during its propagation in the multi-passage cavity 1 along the general direction P of progression in the cavity. More specifically, the main face 3a of the first optical element 3 comprises a plurality of microstructured zones 6, each microstructured zone 6 being arranged on the main face 3a to precisely receive the incident light radiation and apply a primary phase transformation thereto. The alignment part 4 ensures good parallelism between the two reflective optical elements 3, 3′, allowing the second optical element 3′ to be positioned and oriented.

Reference may be made to the various state of the art documents cited to fully understand how the repeated application of these primary transformations allows a selected transformation of the incident light radiation and how the optical element 3 can be designed to implement such a transformation. Reference is also made to these documents to obtain examples of methods for the digital design of microstructures arranged on the main face 3a of the optical element 3. The digital model of these microstructures can be used to manufacture the first optical element 3, for example, by lithography, machining, molding and/or engraving of an optical part.

In this assembly, it is important to maintain very good parallelism between the two reflective optical elements 3, 3′, on the order of a few microradians, to perform spatial transformation to the incident light radiation with precision. This is especially so the longer the cavity and/or the greater the number of reflections.

Regardless of the method used to manufacture the optical element bearing the microstructured reflective surface, it may be desirable for this element to be composed of a plurality of materials. This optical element can thus be formed from a solid part, for example, glass, on which a layer, for example, a layer formed from reflective metal, has been formed. The metal layer bears the microstructuring and the exposed surface thereof forms the main face 3a of the first optical element 3, facing the interior of the multi-passage cavity 1. By providing the first optical element in the form of a solid part with a functional layer bearing the microstructuring, the functions performed by this element can be dissociated. Thus, the nature of the functional layer can be selected for its microstructured and light-reflecting properties. The nature of the solid part can be selected to ensure the rigidity of the assembly and, for example, to dissipate the heat produced in the microstructured zones 6 by the reflections of light radiation.

Regardless of the composition of the first reflective optical element, it is likely to deform with temperature. As this element is securely fastened to the support, this deformation may tend to bend it and cause the reflective surface to deviate angularly from its nominal position at ambient temperature. This is especially so if the first optical element is composed of materials with different coefficients of expansion. The same observations apply to the second optical element. Such deformation affects the parallelism of the two reflective optical elements defining the cavity and, therefore, the quality of the optical transformation performed on the incident light radiation. This transformation is particularly sensitive to the angular deviation of the reflective surfaces, much more so than to a fixed deviation in the relative placement of the optical elements, which would not affect this parallelism.

The parallelism of the two reflective optical elements of a state-of-the-art MPLC optical device can also be affected for other reasons. This is particularly the case when the optical elements 3, 3′, the planar support 7 and the alignment part 4 are not made of the same materials. Again, a variation in temperature with respect to the temperature at which these elements were assembled can lead to variations in the precise positioning of the parts in relation to each other. The application of a mechanical force, such as vibrations or shock or direct pressure on one of the parts, can also cause this positioning to vary.

### BRIEF SUMMARY

The present disclosure aims to remedy all or some of the above-mentioned shortcomings. More specifically, one embodiment of the present disclosure comprises a multi-passage cavity for an MPLC device that is more robust to mechanical stresses than those known in the state of the art. In particular, the multi-passage cavity according to the disclosure can perform a spatial transformation to incident light radiation with precision over a wide temperature range. Embodiments of the disclosure have particular application in providing a multi-passage cavity formed of optical parts consisting of materials with coefficients of expansion that are not all identical, or comprising an optical part formed of materials with distinct coefficients of expansion.

In order to achieve this aim, one embodiment of the disclosure comprises a multi-passage cavity comprising a first and a second optical element respectively having main faces each bearing a reflective surface, at least one of the reflective surfaces being microstructured. The main faces are placed facing each other so that the reflective surfaces are arranged according to a defined geometry.

According to the disclosure, the multi-passage cavity comprises two spacers for assembling the first and second optical elements, the spacers being securely fastened to the main faces of the first and second optical elements to maintain the defined geometry between the two reflective surfaces.

According to other advantageous non-limiting features of the disclosure, taken alone or according to any technically feasible combination:
the microstructured reflective surface has a plurality of microstructured zones defining a general direction of progression of radiation in the cavity, the two assembly spacers extending between the first optical element and the second optical element along the general direction of progression;
the microstructured zones are arranged on the reflective surface between the two assembly spacers;
the two assembly spacers are arranged symmetrically on both sides of the reflective surfaces;
the assembly spacers consist of separate wedges;
the two assembly spacers form the two arms of a wedge having a U-shape;
the two assembly spacers form the two arms of a wedge having an O-shape;
the two assembly spacers are monolithically integrated into the first or second optical element, on the side of its main face, the main face of the first optical element being then directly assembled to the main face of the second optical element;
one dimension of the two assembly spacers is adjustable;
the optical element bearing the microstructured reflective surface is formed of a solid part provided with a functional layer, the functional layer forming the reflective surface, the solid part and the functional layer having different coefficients of thermal expansion;
the two reflective surfaces are planar and positioned parallel to each other;
the first optical element and the second optical element have different coefficients of thermal expansion.

According to another aspect, the disclosure comprises a multi-passage cavity comprising a first and a second optical element respectively having main faces each bearing a reflective surface, the reflective surface of the first optical element being microstructured and the main faces being arranged facing each other so that the reflective surfaces are arranged according to a defined geometry.

According to the disclosure, the multi-passage cavity comprises:
a wedge comprising two assembly parts, the wedge being securely fastened to the main face of the first optical element;
a support having a receiving surface, the wedge and the second optical element being securely fastened to the receiving surface.

According to an advantageous feature, the wedge can be U-shaped or O-shaped.

According to yet another aspect, the disclosure comprises an MPLC optical device comprising a multi-passage cavity according to one of the embodiments disclosed herein and an input stage and/or an output stage assembled to the multi-passage cavity.

### BRIEF DESCRIPTION OF THE DRAWINGS

Other features and advantages of the disclosure will emerge from the following detailed description of the disclosure with reference to the accompanying figures, in which:

FIGS. 1A and 1B depict the multi-passage cavities of a state-of-the-art MPLC device;

FIGS. 2A and 2B respectively depict an assembly view and an exploded view of a multi-passage cavity according to the disclosure;

FIG. 2C is a front view of the main faces of the first optical element and the second optical element of the multi-passage cavity of FIGS. 2A and 2B; and

FIGS. 3A, 3B, 3C, 4, and 5 depict other embodiments of a multi-passage cavity according to the disclosure.

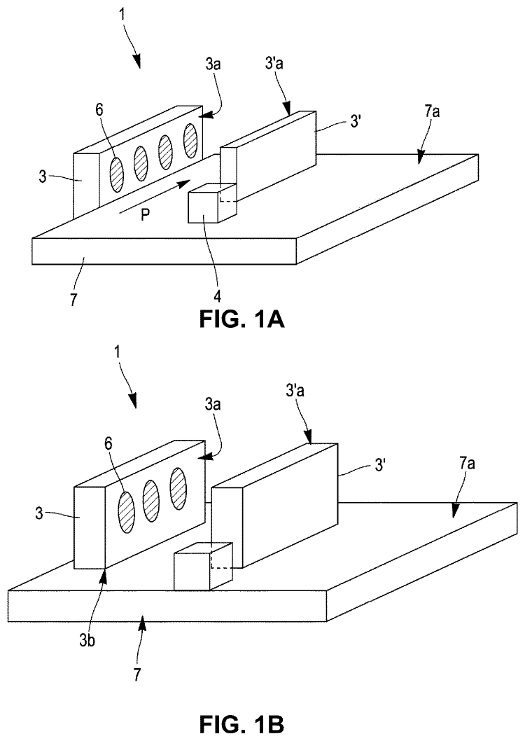

### DETAILED DESCRIPTION

In very general terms, the present description relates to an MPLC optical device for manipulating incident light radiation to form transformed light radiation. Advantageously, the shapes of the incident light radiation and of the transformed light radiation are different from each other. The manipulation of incident light radiation comprises the controlled modification of the transverse phase profile of this radiation, during a plurality of primary transformations that contribute, in combination, to performing a defined optical function. This may involve spatial multiplexing or demultiplexing of the incident radiation or any other modal transformation in the spatial domain, for example, a controlled change in the shape of a light beam making up the incident light radiation. For example, it may involve four or more primary transformations, such as, for example, eight, ten, twelve, fourteen, or even twenty or more elementary transformations.

The MPLC optical device comprises a multi-passage cavity 1 for transforming incident light radiation into transformed light radiation. The optical device may optionally comprise other elements, such as an input stage and/or an output stage to respectively guide the injection of incident light radiation and the extraction of transformed light radiation from multi-passage cavity 1, when this radiation is not simply injected and/or extracted from the MPLC optical device by simple free space propagation.

The multi-passage cavity 1 according to the various embodiments, and with reference to the figures, is composed of an arrangement of two optical elements 3, 3′ respectively having main faces 3a, 3a′, each of these main faces bearing a reflective surface 3b, 3b′. The main faces 3a, 3a′ of the two optical elements 3, 3′ are placed facing each other so that the reflective surfaces define a specific geometry of the multi-passage cavity 1.

In the embodiments depicted, the two reflective surfaces 3b, 3b′ are planar and positioned to be parallel to each other. In this usual case, the defined geometry corresponds to a fixed, scalar spacing value between the two reflective surfaces 3b, 3b′.

This configuration of planar and parallel surfaces, however, is not imperative and, more generally, the defined geometry may correspond to a defined spacing profile separating the reflective surfaces 3b, 3b′ of the two optical elements 3, 3′.

In both cases, however, whether the defined geometry of the cavity is defined as a scalar quantity or as a profile, it is important that it does not vary over time, particularly under the effect of temperature or an external force, so that the MPLC optical device remains perfectly functional. In other words, it is important that the geometry of the cavity does not deviate or deviate excessively from the defined geometry over time.

The reflective surface 3b, 3b′ of at least one of the optical elements 3, 3′ is microstructured. For simplicity of expression, the microstructured reflective surface and the optical element bearing this surface will be referred to as “3b” and “3” respectively in the remainder of this disclosure. Generally speaking, however, the reflective surfaces 3b, 3b′ of the first and/or second optical elements 3, 3′ can be microstructured. If this is not the case, and only one of the optical elements 3 has a microstructured reflective surface 3b, then the other optical element 3′ has a simple reflective surface 3b′, such as a mirror.

This microstructuring is configured to modify the spatial phase of incident light radiation that is reflected a plurality of times as it propagates through multi-passage cavity 1 in the general direction of radiation progression P in the cavity. To this end, the microstructured reflective surface can be composed of a plurality of distinct microstructured zones 6 extending along the direction of progression P. Each microstructured zone 6 is precisely arranged on the main face 3a of the optical element to receive the incident light radiation, reflect it and apply a primary phase transformation thereto.

However, the microstructured zones 6 need not be distinct from one another and any other microstructuring configuration could be suitable, as long as it allows a specific transformation of the incident radiation to be applied during multiple reflections.

“Microstructured surface” is understood to mean, by way of example, that the face or surface can have “pixels” whose dimensions range from a few microns or less to a few hundred microns or more. Each pixel has an elevation with respect to a mean plane defining the face or surface in question, of at most a few microns or at most a few hundred microns. The microstructured surface can thus have a resolution (in its mean plane) and an elevation (in “peak to valley”) that can extend from a fraction of the central wavelength of the radiation whose spatial phase is to be modified, up to several hundred times this wavelength, or even several thousand times this wavelength.

The optical elements 3, 3′ can be of any suitable shape. As already mentioned, these optical elements are selected so that their reflective surfaces 3b, 3b′ are perfectly planar (apart from microstructuring), but this is not a necessity. Generally speaking, the microstructuring of the reflective surface 3b (or reflective surfaces) is determined, during its digital design, according to the shape and relative positioning of the reflective surfaces 3b, 3b′ and, therefore, according to the geometry of the cavity. It is, therefore, important that this geometry remains stable to allow precise transformation of the incident light radiation, particularly when the multi-passage cavity 1 is subjected to forces tending to deform it, for example, by forces generated during significant temperature variations.

It should be noted that there may be a discrepancy between the ideal cavity geometry used to design the microstructuring and the measured spacing between the reflective surfaces 3b, 3b′, which may be due to manufacturing tolerances of the optical parts forming the cavity and to assembly tolerances of these parts. This deviation, when stable over time and moderate, does not affect the correct operation of the device or can be compensated for by adjusting the position and angle of the incident light radiation with respect to the cavity.

The defined geometry, therefore, corresponds substantially to the spacing profile between the two reflective surfaces 3b, 3b′ when this profile is measured at room temperature and without any mechanical stress on the cavity.

The first optical element 3, the second optical element 3′, and all other parts forming the cavity, can be selected from any suitable material. The material may be quartz, glass, fused silica, a metal or silicon, or even a plastic material. Within the scope of the present disclosure, it is not necessary for the parts forming the cavity to be made of materials having identical coefficients of thermal expansion.

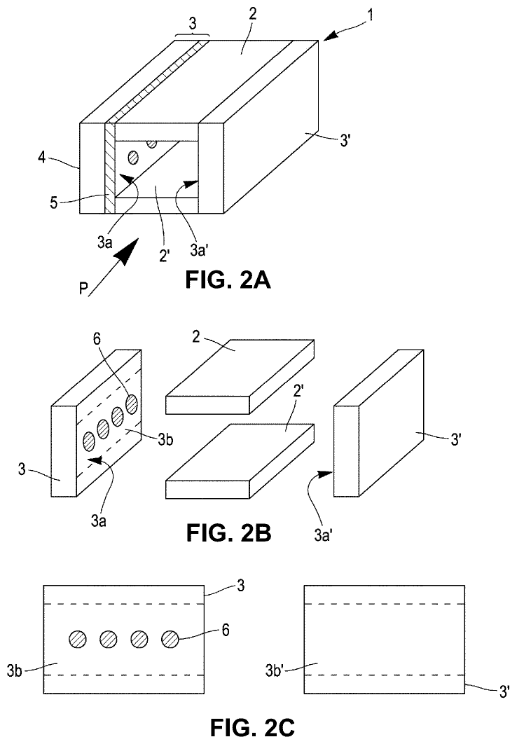

The optical elements 3, 3′, or some of them, may also be formed from a plurality of materials having different coefficients of thermal expansion. This is particularly true of the optical element 3 bearing the microstructured reflective surface 3b. As can be seen in FIG. 2A, this may thus be formed of a solid alignment part 4 with a functional layer 5, the functional layer forming the microstructured reflective surface 3b, the solid alignment part 4 and functional layer 5 having different coefficients of thermal expansion. In the introduction to this application, we explained the advantages of such an arrangement.

The solid alignment part 4 may thus consist of quartz, glass, fused silica, a metal or silicon, or a plastic material. The functional layer 5 may, for example, consist of or comprise a metal (gold, silver, nickel), a dielectric or even an insulated resin (e.g., resin distributed under the brand name ORMOCOMP®). The functional layer 5 may be formed on the solid part by any suitable technique: assembly, deposition, plating, etc.

### First Approach

To allow robust assembly of the first optical element 3 and the second optical element 3′, a multi-passage cavity 1 conforming to a first approach also comprises two spacers 2, 2′ allowing the first and the second optical element 3, 3′ to be directly assembled together. These two so-called “assembly” spacers are securely fastened to the main faces 3a, 3a′ of the first and the second optical element 3, 3′. Each assembly spacer 2, 2′ is securely fastened to the main face of the first optical element 3 and the main face of the second optical element 3′.

“Securely fastened” is understood to mean that each assembly spacer 2, 2′ is held to the two optical elements 3, 3′ without any degree of freedom.

They are precisely dimensioned to maintain the defined geometry between the reflective surfaces 3b, 3b′ borne by the main faces 3a, 3a′ of the two optical elements 3, 3′, even when significant forces are applied to the multi-passage cavity 1. In other words, significant forces applied to the multi-passage cavity 1 may deform some of the parts composing it, but these deformations do not preferentially affect the reflective surfaces 3b, 3b′, so that the defined geometry can be preserved. Thus, despite the presence of a deflection that may be caused by mechanical forces of thermal origin, for example, the two reflective surfaces 3b, 3b′ present a stabilized average angle, these angles having a significant impact on the transformations effected by the cavity. To promote this stabilization, the two assembly spacers 2, 2′ can be positioned symmetrically on either side of the reflective surfaces 3b, 3b′.

Advantageously, and as can be seen from the figures, the two assembly spacers 2, 2′ extend between the first and the second optical element 3, 3′ along the general direction of progression P of the radiation in the cavity. When the multi-passage cavity 1 is formed, the microstructured zones 6 are arranged on the reflective surface 3b arranged between the two assembly spacers 2, 2′.

In this configuration, a force applied to the cavity or a deformation of one of the cavity parts has little or no effect on the spacing of the reflective surfaces 3b, 3b′ and, therefore, on the internal geometry of the cavity, whose parameters are robustly fixed by the presence of the two assembly spacers 2, 2′.

When the spacers 2, 2′ are assembled on both sides of the reflective surfaces, along the direction of progression P, the cavity retains two lateral openings for injecting incident light radiation therein and for collecting transformed light radiation.

The assembly spacers 2, 2′ can take the form of at least one additional part, referred to as a “wedge” in the remainder of this description. This or these wedge(s) can be assembled to the main faces 3a, 3a′ of the optical elements 3, 3′ using an adhesive material (which can be UV or temperature curable), by mechanical clamping, by laser fusion or by molecular adhesion, for example.

In the embodiment shown in FIGS. 2A and 2B, the two assembly spacers 2, 2′ consist of two separate wedges.

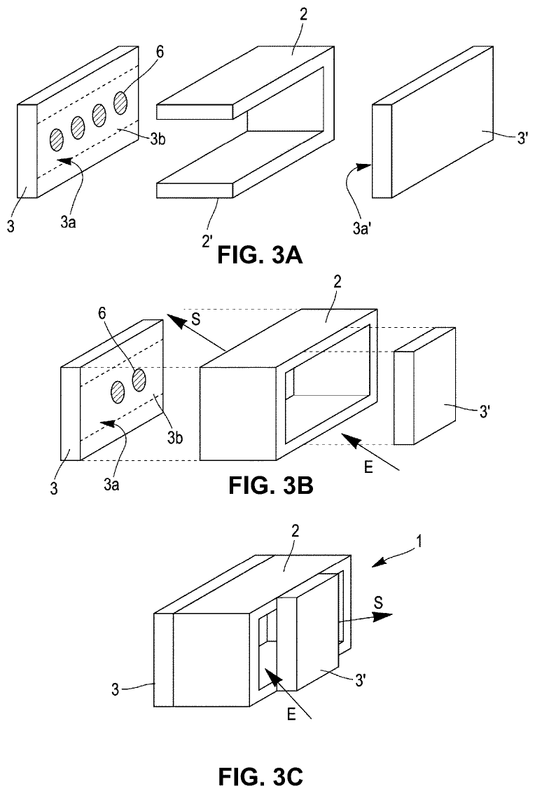

In the embodiment shown in FIG. 3A, the two assembly spacers 2, 2′ form the two arms of a single U-shaped wedge. In this configuration, one of the lateral openings of the cavity is closed by the base of the U.

In the embodiment shown in FIGS. 3B and 3C, the two spacers form the two arms of a single O-shaped wedge, with the two lateral openings of the cavity then being closed by the wedge.

Nevertheless, in order to allow light radiation to propagate through the lateral openings, the wedge material can be selected to be transparent to incident or transformed light radiation and thus allow the optical device to function properly.

More generally, the spacers 2, 2′ can be configured and assembled with the optical elements 3, 3′ to provide lateral or facial openings allowing the propagation of light radiation into and out of the multi-passage cavity 1. These openings may be mechanical or optical in nature, through the transparency of the material forming the spacers. Alternatively, passages could also be provided in one and/or other of the first and the second optical element 3, 3′, these passages allowing light radiation to propagate into and out of the multi-passage cavity 1.

In the embodiment shown in FIG. 3C, two facial openings, referenced E and S, are provided to respectively allow incident radiation to be injected into the cavity and transformed radiation to be ejected from the cavity. These openings are of a mechanical nature and are arranged between the second optical element 3′ and the wedge. The second optical element 3′ has a dimension, in the general direction of progression P, that is smaller than that of the wedge, thus freeing up passages on both sides of the second optical element 3′ forming the openings.

In the embodiment shown in FIG. 3B, a first facial opening E is similar to that shown in FIG. 3C, arranged between the second optical element 3′ and the wedge. A second facial opening S is arranged between the wedge and the first optical element 3. The first and the second optical element 3, 3′, therefore, each have a dimension, in the general direction of progression, that is smaller than that of the wedge. This, therefore, frees up two passages forming the facial openings E, S of the cavity.

Note that a cavity having facial openings is compatible with all the embodiments shown, and not just with an O-shaped wedge as shown in FIGS. 3B and 3C.

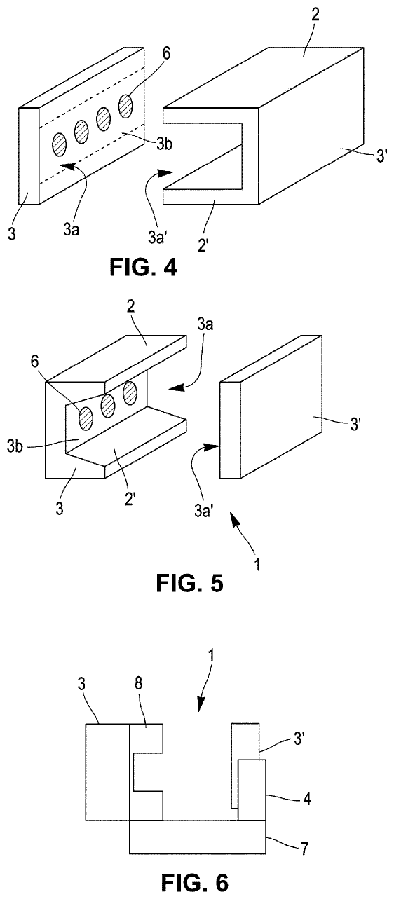

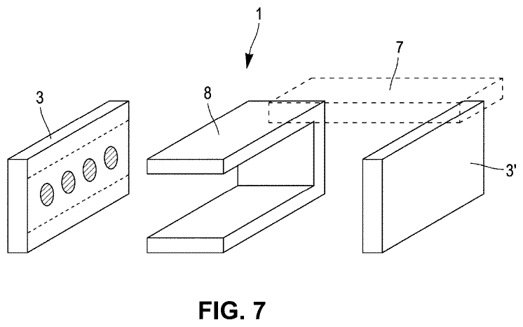

Rather than being provided in the form of at least one wedge, the two assembly spacers can be monolithically integrated into the first or the second optical element, on the side of its main face. These embodiments are shown in FIGS. 4 and 5. These spacers then form protruding parts (with respect to the reflective surface) of the optical element bearing them. In this case, the main face 3a of the first optical element is directly assembled to the main face 3a′ of the second optical element, via the projecting parts forming the spacers, without the multi-passage cavity 1 comprising any other parts required for its construction.

Generally speaking, in this first approach, no parts other than the first and the second optical element, and optionally, the wedge(s), are required to form the multi-passage cavity 1. In particular, there is no need to provide a support.

In an embodiment consistent with this first approach, at least one of the spacers may be configured so that its dimension extending from one reflective surface to the other is adjustable. For example, at least one of the spacers may be fitted with a heating element, such as a resistor, or the spacer may be formed from a piezoelectric material equipped with control electrodes. By controlling the voltage applied to the resistor or electrodes, it is possible to finely adjust the size of the spacer separating the two optical elements, to bring them closer to the defined geometry.

### Second Approach

In a second approach, aimed at proposing a robust multi-passage cavity 1 and of which some embodiments are shown in FIGS. 6 and 7, a planar support 7 is provided having a receiving surface to which the second optical element 3′ is securely fastened (that is, assembled without any degree of freedom). This assembly can be carried out directly or via an alignment part 4, allowing the second optical element 3′ to be oriented relative to the planar support 7, as shown in FIG. 6.

A wedge 8 comprising two assembly parts is also held securely on the main face 3a of the first optical element 3. This can be a U-shaped or an O-shaped wedge, as has already been presented in an implementation mode consistent with the first approach. The first optical element 3 has a microstructured reflective surface. The assembly parts of the wedge 8 are preferably assembled on both sides, and advantageously symmetrically, of the microstructured reflective surface 3b of the first optical element 3. They can extend along the general direction of progression P. They tend to stiffen the first optical element 3 on the side of its reflective surface 3b, which prevents the deformation of this surface under the application of forces.

The wedge 8, bearing the first optical element 3, is also securely fastened to the receiving surface of the planar support 7 in an arrangement defining the defined geometry between the two reflective surfaces.

As with the first approach, significant forces applied to the multi-passage cavity 1 in accordance with the second approach may deform some of the parts composing it and, in particular, the first optical element 3. However, these deformations do not occur preferentially at reflective surfaces, so the defined geometry can be preserved.

As can be seen in FIG. 7, it is not necessary for the planar support 7 to be in contact with the full extent of one side of the wedge 8 and one side of the second optical element 3′. It may be an element forming a bridge between these two parts, in contact on only part of their sides.

Naturally, the disclosure is not limited to the two approaches and embodiments described and it is possible to add alternative embodiments without departing from the scope of the invention as defined by the claims.

Thus, the optical device may optionally comprise an input stage and/or an output stage assembled to the cavity, respectively guiding the injection of incident light radiation and the extraction of transformed radiation. These stages may correspond to an optical fiber or an optical fiber network (this or these fibers may or may not be lensed), or comprise a laser source, an optical element such as a dichroic, a lens, a concave mirror, a polarization controller, a MEMS, a tip/tilt control mirror, an SLM matrix, a diffraction grating, a diaphragm, a glass pane with surface treatment. In particular, these stages can be attached to one at least of the edges of the optical elements or to one at least of the spacers.

1.-20. (canceled)

21. A multi-passage cavity, comprising:
first and second optical elements respectively having main faces each bearing a reflective surface, the reflective surface of at least one of the first and second optical elements having a plurality of microstructured zones aligned along a general direction of progression of radiation in the cavity, the main faces facing each other so that the reflective surfaces are arranged according to a defined geometry of the multi-passage cavity, the at least one of the first and second optical elements having the reflective surface having the plurality of microstructured zones comprising a solid part and a functional layer on the solid part, the functional layer forming the reflective surface, the solid part and the functional layer having different coefficients of thermal expansion; and
two spacers for assembling the first and second optical elements, each of the spacers being securely fastened to the main face of the first optical element and to the main face of the second optical element to maintain the defined geometry between the two reflective surface, the two assembly spacers extending between the first and second optical elements in the general direction of progression, the microstructured zones located between the two assembly spacers.

22. The multi-passage cavity of claim 21, wherein the two assembly spacers are arranged symmetrically on both sides of the reflective surfaces.

23. The multi-passage cavity of claim 21, wherein the two spacers comprise separate wedges.

24. The multi-passage cavity of claim 21, wherein the two spacers form two arms of a U-shaped wedge.

25. The multi-passage cavity of claim 21, wherein the two spacers form two arms of an O-shaped wedge.

26. The multi-passage cavity of claim 21, wherein the two spacers are monolithically integrated into the first or second optical element, on the side of its main face, the main face of the first optical element being directly assembled to the main face of the second optical element.

27. The multi-passage cavity of claim 21, wherein a dimension of the two spacers is adjustable.

28. The multi-passage cavity of claim 21, wherein the two reflective surfaces are planar and positioned parallel to each other.

29. The multi-passage cavity of claim 21, wherein the first optical element and the second optical element have different coefficients of thermal expansion.

30. An MPLC optical device, comprising:
a multi-passage cavity according to claim 21; and
an input stage and/or an output stage assembled to the multi-passage cavity.
